(19) United States
(12) Patent Application Publication
(10) Pub. No.: US 2001/0010838 A1
(43) Pub. Date: Aug. 2, 2001

(54) IMPROVEMENTS IN AND RELATING TO COLOUR COATING

(76) Inventor: James Eldon, Hampshire (GB)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/767,736

(22) Filed: Jan. 24, 2001

(30) Foreign Application Priority Data
Jan. 28, 2000 (GB) 0002028.9

(51) Int. Cl. B05D 5/06; B05D 3/02; B05D 1/38

(52) U.S. Cl. 427/385.5; 427/407.1

(57) ABSTRACT

Improvements in and relating to color coating A method of applying a decorative surface finish similar to an intensely colored anodised aluminium is described. The finish is particularly suited for coating molded plastics material articles such as covers (1) for radio telephones. The finish comprises a reflective base coat (6), an intermediate transparent colored layer (8) and a transparent protective top coat (10) which optionally includes a UV screen.

### BACKGROUND OF THE INVENTION

The present invention relates to a method for colour coating an article, particularly, although not exclusively, a mobile telephone handset.

Wireless communications markets are becoming increasingly complex and sophisticated. This is shown in the need for manufacturers, distributors and network operators to express their identity through the cosmetic attributes of their products, and is compounded by the reduced size and broadening functionality of communications products, allowing a changing perception of the role of communications products in everyday life of consumers. That is, the identity of the user is expressed increasingly through the product in a similar way to clothing or automobiles.

As a result of this, there is a greater need for decoration technologies that increase perceived quality and give an edge in the market place, allowing greater differentiation and an increased sense of fun.

Traditionally, colour has been imparted to such articles through a variety of processes: colour pigment has been placed directly in the plastic substrate; by application of layers of printed attached film to the substrate in the plastic moulding tool during the moulding process; by using so-called aqua-graphics, that is patterns applied from the surface of water; and finally by applying fast cure pigmented paints with, in most cases, a protective clear top coat. The latter technique has commonly been used for the housings of radio telephones. In a known method, a two-coat system is used in which the first coat is a 1-pack pigmented coat applied wet. This coat contains adhesion promoters and solvents to bond the pigments to the substrate, usually forming a molecular matrix with the substrate material.

Where a more striking finish is desired, various mica, metallic and interference effect coatings have been proposed. These coatings utilise platelet pigments that are intended to lay parallel to the surface being coated in order to achieve reflective effects. Very fast drying time, low surface tension and low viscosity of this coat when wet are essential for the correct orientation of the pigment platelets or reflective particles. Clearly, the more disrupted the orientation of these particles, the lower the reflective characteristics of the layer. The presence of colour pigments within the layer is, of course, a source of disruption to the platelet pigments. Typically, the thickness of this layer is usually 6-12 microns. A second protective clear coat is usually applied over this pigmented coat. The thickness of this protective layer is usually 10-20 microns.

In an attempt to overcome the disadvantages posed by the presence of colour pigments, it has previously been proposed to lay a transparent coloured protective coating over a reflective layer consisting solely of correctly orientated reflective particles. However, the physical characteristics of such a protective coating such as its viscosity, curing time and the like are such that very careful control of the application of such a finish to an article is necessary. This mitigates against the use of the technique on high volume, high quality articles as any failure to control variations in thickness of the transparent coloured layer will have a severe optical effect, resulting in an unacceptable quality level. Furthermore, the finish can suffer from poor reliability performance owing to poor adhesion of the protective coat to the reflective layer.

It is thus an aim of the present invention to provide a method of coating an article which can consistently provide a high quality decorative finish particularly for high volume products. It is a further aim of the present invention to provide a paint composition which can be used in providing a high quality decorative finish to an article.

### SUMMARY OF THE INVENTION

According to one aspect of the invention there is provided method of applying a decorative surface finish to an article having a substrate, comprising applying a transparent coloured film over a reflective surface of the substrate and during the curing period of the coloured film applying a transparent protective film over the coloured film.

The transparent film may contain either a dye or a pigment to obtain a desired colour. Where the substrate from which the article is formed is not itself highly reflective, the method may include the initial step of applying a reflective coating to the substrate with a dry film thickness in the region of 5 microns. Preferably, the application of the coloured film is controlled to ensure that its thickness does not vary by more than 2 to 4 microns. In order to reduce any UV induced degradation of the finish, a UV screen may be included in the protective film. The coloured film is manufactured using smaller than usual amounts of hardener and optionally reducer. The reduction in the amount of hardener improves the adhesion between the semi-cured coloured film and the protective film. In addition the semi-curing time of the film is reduced possibly to 5 minutes or less at room temperature and pressure thereby facilitating good adhesion with the protective film or top coat and accurate coating of an article, as there is less time for the film and the dye, or pigment, providing colour to the film, to flow or swim and destroy the homogeneity of the colour finish. A lower reducer volume also promotes rapid semi-curing of the film and results in a consistent layer.

In accordance with a further aspect of the invention, there is provided an article having a reflective substrate, a transparent coloured intermediate layer and a transparent topcoat.

The reflective surface may be either a polished substrate of the article or a base layer of reflective particles applied as a film over said substrate. The intermediate layer will suitably comprise a two-pack polyurethane clearcoat base to which is added a hardener, a colour concentrated dye or clear pigment and a fast reducer. The volume of hardener added to the intermediate clearcoat base is reduced in comparison with that typically prescribed for a clearcoat base when used as a conventional paint. Similarly, the amount of reducer added to the clearcoat base may also be reduced in comparison with the conventional volume added to a clearcoat base.

In order to understand the present invention, a particular embodiment thereof will now be described by way of example and with reference to the accompanying drawings, in which:

### BRIEF DESCRIPTION OF THE DRAWINGS

FIG. 1 is a fragmentary cross-sectional end view of a front cover of a radio telephone handset having a finish in accordance with the method of the invention;

FIG. 2 is a diagrammatic view of the layout of a production facility for coating the housing of FIG. 1; and

FIG. 3 is a diagrammatic view illustrating the optical effect achieved by the finish of FIG. 1.

### DETAILED DESCRIPTION OF THE INVENTION

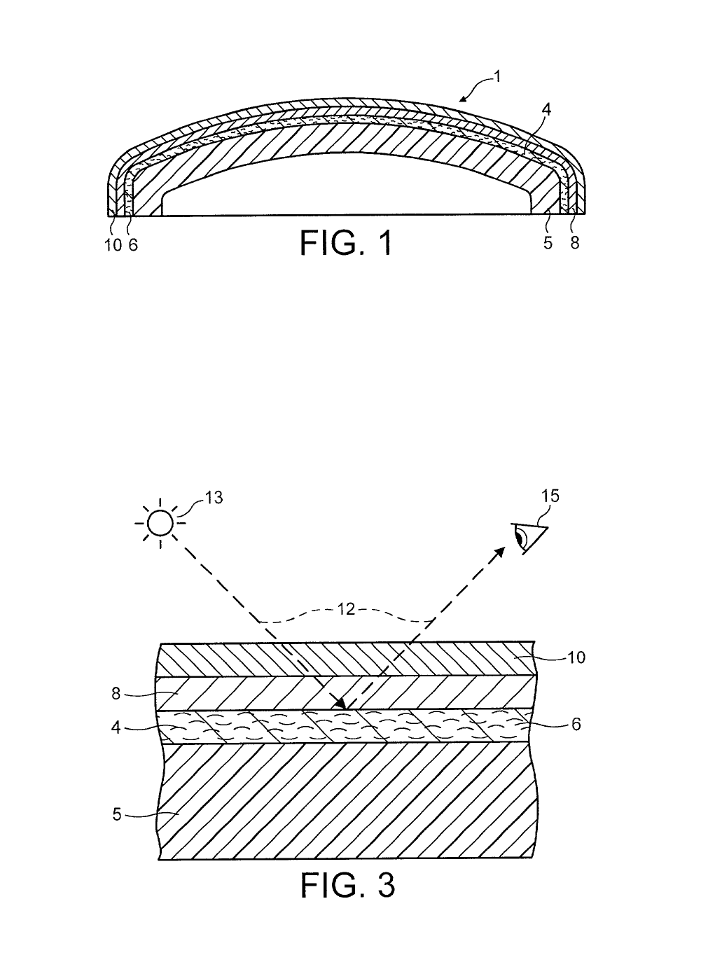

Referring to the FIG. 1, there is shown a cross-section through a front cover 1 of a radio telephone handset. The cover 1 is formed from any suitable engineering plastics material such as acrylonitrile butadiene styrene (ABS), for example, although other plastics and indeed metals are equally acceptable as substrates for the finish described below.

A plurality of such covers are placed face-up on a conveyor 2 within a paintshop. No pre-coating processes are required other than simply ensuring that each cover is clean. Each cover 1 passes on the conveyor 2 into a first spray station 3 dispensing a highly reflective paint comprising a suspension of metal particles or flakes 4 held within a fast flash-off solvent carrier. The metal particles, suitably aluminium, adhere to the exposed substrate 5 of the cover 1 and form a base coat 6 with a dry thickness of approximately 5 microns. The solvent is selected to assist in the orientation of the particles 4 such that they lie in a plane substantially parallel to the substrate 5.

The base coat 6 is allowed to dry before the cover 1 enters a further spray station 7 for the application of an intermediate layer 8. Once at this station 7, the cover 1 is sprayed via a further set of nozzles with the pre-mixed components of a two-pack paint tinted to provide a pre-selected colour. The composition of the paint that forms the intermediate layer 8 is a two-pack polyurethane clearcoat base containing a hardener, a reducer and a colour concentrated dye. The volumes of the hardener and reducer are typically less than that prescribed for conventional application of the two-pack paint to ensure that the curing, and viscosity of the paint are such to permit accurate control of the film thickness, and good adhesion with the top protective coat. To this end, the ratio of hardener to clearcoat base is 5-15%, the ratio of reducer to clear coat and hardener is 50-80% and the ratio of dye or dyes to clearcoat base with hardener and reducer is 20-30%. This can be expressed in the following terms, assuming that to the clear coat base there is added in turn the hardener, then reducer and finally the dye:

1) Paint (clear coat base) 100% (100 units)

2) Hardener 5-15% of mix so far (5-15 units)

3) Thinner 50-80% of mix so far (52.5-92 units)

4) Dye 20-30% of mix so far (31.5-62.1 units)

Again, expressed in another way, to every 100 units of volume of clearcoat base there is added 5 to 15 units of hardener, 52.5 to 92 units of reducer and 31.5 to 62.1 units of dye. The variation in the above figures result from the selection of cure temperatures and times to suit the application means and selected colour.

Following the application of the intermediate layer 8, the cover 1 is conveyed within several minutes to a third station 9 where a clear, protective top coat 10 is applied over the semi-cured intermediate layer 8. Typically, the above proportions of hardener and reducer will ensure that the intermediate layer 8 remains semi-cured for several minutes following the application of the topcoat 10. Consequently, there is provided the best compromise between minimising the time in which the dyes may swim and the film may flow over the surface contours of the cover 1 and providing sufficient time for a molecular matrix to be formed between the top coat 10 and the intermediate layer 8 thereby ensuring good adhesion therebetween. The protective top coat 10 further includes a UV screen to block UV light that could otherwise have a deleterious effect on the colour stability of the intermediate layer 8.

Subsequently, the cover is conveyed into an oven 11 where it remains for around thirty minutes or so at a temperature of around 60° C. to 70° C., before being dumped from the conveyor in to a collection bin (not shown).

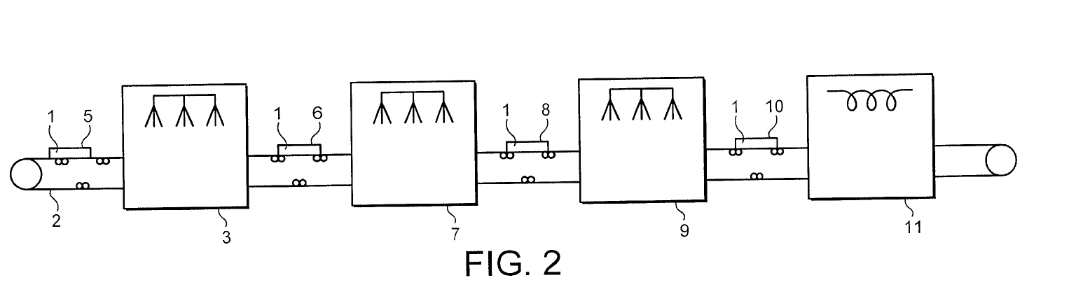

The visual effect resulting from the above-described method is best understood by reference to FIG. 3. An exemplary light ray 12 is shown leaving a source of light 13 that may be natural or artificial. The light ray 12 passes through the transparent top coat 10 through the intermediate layer 8 where the light is filtered by the dye contained therein and is reflected by the particles 4 contained within the base coat 6. The reflected ray 12 then passes once more through the intermediate layer 8 where it is once again filtered before passing through the top coat 10 to reach a viewer's eye 15. The visual effect resulting from the filtering and reflection of light incident on this finish is of intensely coloured anodised aluminium.

It will be appreciated by those skilled in the art that the above-described embodiment is only one method of obtaining an intense colour surface coating. In particular, although reference is made to a dye throughout the foregoing, a clear pigment could be used to impart colour or tint to the intermediate layer. The choice of a pigment would be dictated to a great extent by its ability to form a suspension in the wet coat. With respect to the method by which the finish is applied to a cover, rather than utilising a conveyor system, the cover may be sprayed manually using standard HVLP spray guns and/or robotic manipulators. The method may be also be used with other engineering materials and has applications in the coating of not just covers but also other articles such as cases, panels and even packaging. Furthermore, it will be recognised that careful determination of the volumes of hardener, reducer, and dye will be required for each article which it is intended to coat as will the selection of curing time and temperatures.

What is claimed is:

1. A method of applying a decorative surface finish to an article having a substrate, comprising applying a transparent coloured film over a reflective surface of the substrate and during the curing period of the coloured film applying an transparent protective film over the coloured film.

2. A method as claimed in claim 1, in which the reflective surface of the substrate is formed by an initial step of surface coating with a film of reflective particles.

3. A method as claimed in claim 1, wherein the coloured film includes a dye.

4. A method as claimed in claim 1, wherein the coloured film includes a clear pigment.

5. A method according to claim 1, wherein the coloured film is formed from a two-pack paint in which the volumes of hardener and optionally reducer added to a clearcoat base are reduced.

6. A method as claimed in claim 5, wherein the ratio of hardener to clearcoat base is around 0.05 to 0.15 by volume.

7. A method as claimed in claim 5, wherein the ratio of reducer to clearcoat base is around 0.525 to 0.92 by volume.

8. A method as claimed in claim 5, wherein the ratio of dye to clearcoat base is around 0.315 to 0.621 by volume.

9. A method according to claim 1, wherein an ultra-violet screen is added to the protective film.

10. A method according to claim 1, wherein the coloured film is allowed to cure at room temperature.

11. A method as claimed in claim 1, wherein the protective film is cured at temperature in the range of 60° C. to 70° C. for at least 20 minutes.

12. A method as claimed in claim 1, including the step of maintaining the variation in thickness of the coloured film to within 2 to 4 microns.

13. A radio telephone housing having a substrate on which has been applied a surface finish in accordance with the method of claim 1.
